(19) United States
(12) Patent Application Publication
(10) Pub. No.: US 2019/0000711 A1
(43) Pub. Date: Jan. 3, 2019

(54) APPARATUS FOR MASSAGING A BODY PART OF A USER

(71) Applicant: William John Pundyk, Beaverton, OR (US)

(72) Inventor: William John Pundyk, Beaverton, OR (US)

(21) Appl. No.: 15/593,329

(22) Filed: Jun. 30, 2017

(51) Int. Cl. A61H 15/02; A61H 1/00; A61H 23/00

(52) U.S. Cl. CPC A61H 15/02; A61H 2015/0071; A61H 23/00; A61H 1/00

(57) ABSTRACT

Disclosed is an apparatus for massaging a body part of a user comprising a housing formed from a flexible material, a interchangeable spherical resilient body received within the housing, the interchangeable spherical resilient body being made from soft material and at least one connecting material coupled to opposite ends of the housing, the at least one connecting material having a predetermined length. The flexible material may include a tube like fabric or mesh material. The interchangeable spherical resilient body may include at least different sizes, spherical or non-spherical shape, and different textures.

### BACKGROUND OF THE INVENTION

Back pain and muscle tension is a common complaint. Most people in the United States will experience back pain at least once in their lives. Back pain is one of the most common reasons people go to the doctor or miss work according to Mayo Clinic. A person can take measures to prevent or lessen most back pain episodes. If prevention fails, simple home treatment and proper body mechanics will often heal a person's back within a few weeks and help keep it functional for the future. Treatment for back pain depends on the person's history and the type and severity of pain. The vast majority of back pain cases get better within six weeks without surgery. Back massage, trigger point therapy to relieve muscle tension and spinal adjustments are normally part of a treatment plan. Kinesiotherapy therapy treatment which is a massage and movement based therapy may also aid in recovery and has effects on the various systems of the human body; a massage will relax or tone muscles and increase circulation when these techniques are used. Methods of treatment that can be administered by a physical therapist, chiropractor or massage therapist can be expensive. Some professionals will recommend home treatment which can include strengthening and stretching exercises, massage therapy and/or self-therapy to speed up the healing process.

This invention (device and method of use) is new and unique and one of a kind when compared to other devices that use a massage ball, current devices may have the user either set the ball on the floor or place it behind the users back to position the ball which can be difficult to accomplish and/or control the position of the ball which may require reaching behind your back which can be painful and increase muscle tension in the arms and back muscles when a user already may have a pinched nerve, tense, stiff, or injured back and limited range of motion. Some other devices have a handle or handles which require the person using the device to reach back or hold on to or grasp the device with a string or rope in order to use the device which can actually increase back muscle tension when positioning or using the ball device behind a user's body. Existing devices do not allow the user to wear or adjust the device over one shoulder and under one arm like a closed loop sling. Further, they do not allow the user to easily exchange the ball attached to the device with a ball of their choice.

### SUMMARY OF THE INVENTION

The present invention is an adjustable self-massage ball device with an interchangeable ball that is worn by the user over one shoulder and under one arm like a closed loop sling. Simply place the device on the body then position the ball then adjust and initiate self-massage without reaching for or holding on to the device.

The object of the present new invention is to remedy the above mentioned limitations of existing massage ball devices which can be used to administer self-massage. This invention will eliminate the need to place or reach the user's hands or arms behind the body to position or use the ball or hold on to the device when in use thereby allowing the arm and back muscles to remain in a more relaxed state.

This invention allows a user to wear and adjust the self-massage ball device over one shoulder and under one arm like wearing a closed loop sling. The interchangeable ball feature allows a user to exchange the massage ball within the ball container and change the size, quantity and/or the density or texture of the ball used. This invention can be worn and used by individuals such as a person with back muscle tension, computer operators, office workers and athletes. In addition physical therapist, chiropractors, sports doctors can recommend the use of this device as part of a patient home therapy regime/prescription. This device can be used by a person with interest in using self-massage, self-healing according to Dr. Michael A. Cohen and trigger point release techniques as in the Trigger Point Self-Care Manual by Donna Finando, L.Ac., L.M.T. Other aspects of this invention will become apparent to those skilled in the art.

Other features and advantages of the present invention will become more apparent from the following detailed description, taken in conjunction with the accompanying drawings which illustrate, by way of example, the principles of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is sides view of the present invention a self-massage device and its elements;

FIG. 2 is a side view of the connecting material variation 2; and

FIG. 3 is a side view of the single sliding locking adjustment variation 2.

FIG. 4 is a perspective view of the device being worn and shown on the back of the user's body; and

FIG. 5 is a perspective view of the device being positioned by the user shown on the front of the user's body.

FIG. 6 is a perspective view of the device being adjusted by the user shown on the front of the user's body; and

FIG. 7 is a rear view of the user wearing the positioned and adjusted device with hands free from the device.

FIG. 8 is a side view of the user wearing the device and preparing to lean the body against the vertical surface; and

FIG. 9 is a user laying on a horizontal surface wearing and using the to device free from the use of hands; and

FIG. 10 is a user in a sitting position wearing and using the device free from the use of hands; and

FIG. 11 is a user in a squatting position against a vertical surface wearing and using the device free from the use of hands.

### DETAIL DESCRIPTION OF THE INVENTION

The following detailed description refers to the accompanying drawings that illustrate the embodiments of the present invention. Other embodiments are possible and modifications may be made to the embodiments without departing from the spirit and scope of the invention. Therefore, the following detailed description is not meant to limit the invention. Rather the scope of the invention is defined by the appended claims.

The invention described herein is not limited in its application to the details of construction and the arrangement of the components set forth in the following description or illustrations in the provided figures. This invention is capable of various embodiments and can be used or applied in other ways.

Referring now to the invention in more detail, in FIG. 1 is shown the device 10 elements described herein shown in FIG. 1 is an adjustable closed loop sling type self-massage device with a ball container 16 and interchangeable ball 14.

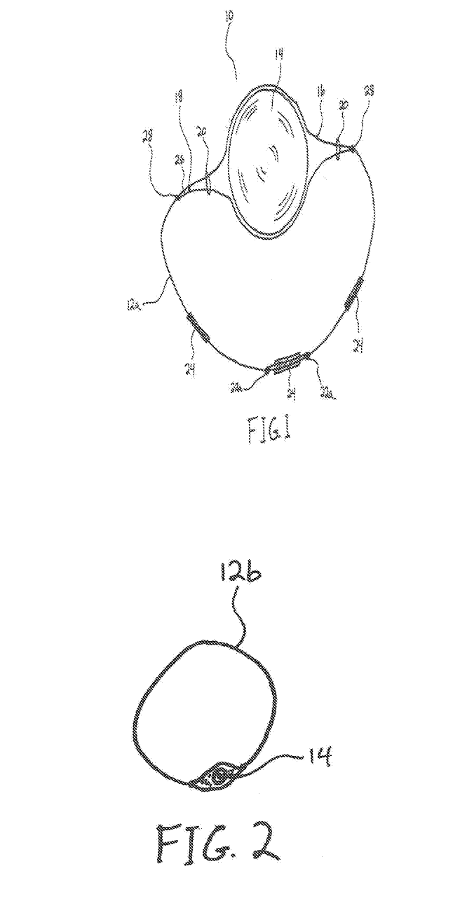

In more detail, still referring to the invention of FIG. 1 the connecting material 12a may be several inches to several feet in length and the material may be a cord, rope, fabric, elastic, and may be either retractable or a fixed length and can be any material that can be connected or attached in a closed loop sling configuration by any means including a connecting knot 28, clamp, adhesive or any type of connecting or attaching method to the ball container 16. A sliding or stationary material such as foam or tubing may be used over the connecting material 12a to act as a gripping material 24 or covering over the user adjustable connecting material 12a. Referring to FIG. 2 the connecting material 12b may also be a fixed length without the adjustable size option.

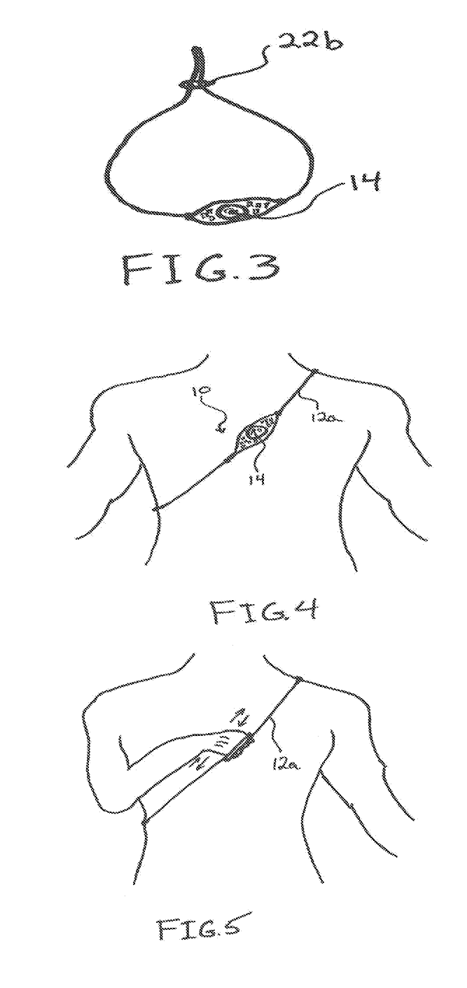

In more detail, referring again to FIG. 1 of the invention the adjustment type shown is a double sliding knot adjustment 22a or can be any mechanism or functionality to adjust the connecting material 12a by increasing or decreasing the circumference of the connecting material 12a closed loop sling to fit the users body comfortably and keep the ball in the desired area of the users muscle group or spine location while in use. A double sliding knot adjustment 22a used in this embodiment is used for adjustment and also may use as shown in FIG. 3 a single sliding locking adjustment ring 22b or grommet or any other method or mechanism which allows the connecting material 12a from the ball container 16 to form an adjustable circumference closed loop self-massage device 10. Referring to FIG. 2 the connecting material 12b may also be a fixed length without the adjustable size option.

In more detail, referring again to the invention of FIG. 1 the ball container 16 material may be constructed of various types of fabric, mesh, tubing, canvas or any other material to allow the insertion of a spherical or non-spherical object. The ball container access 26 which may or may not be accessible by the user and sealed at time of assembling and may incorporate an opening and closing method that is accessible by the user. The ball container access 26 opening may consist of one or multiple ball container access 26 areas and may be opened and closed either with a drawstring 18, zipper, hook and loop material or by any other method which will allow the user to exchange the ball 14 for a different size/diameter or change the quantity of balls and/or the density of the ball 14 and may be spherical, oblong or various shapes and sizes or textures and may include heat, cold, vibration or another available type of trigger point ball. The ball container size adjustment 20 may be on one or both sides of the container and may use a band, clamp, rope or any method that would enable a user to either expand or contract the ball container 16 size to compensate for various ball size diameters, quantity, arrangements, shapes, or textures.

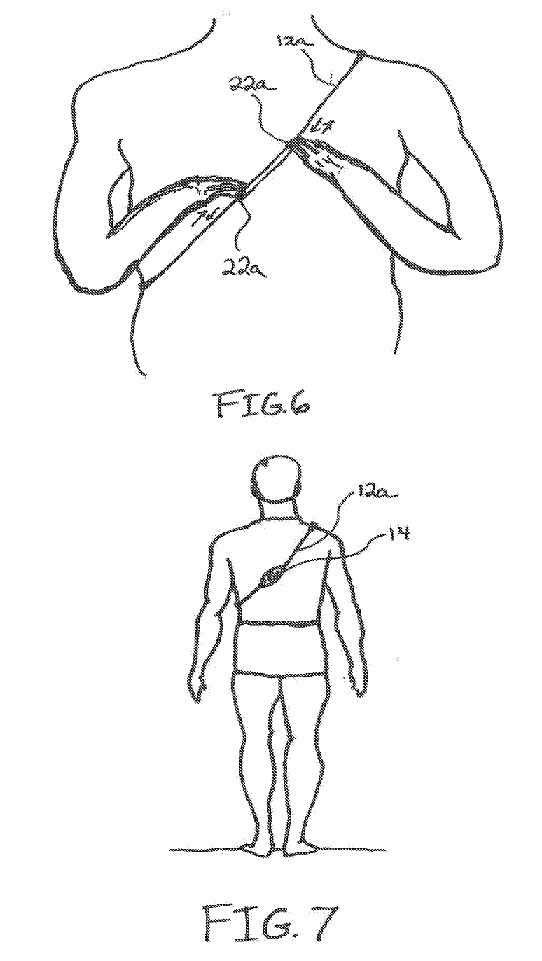

Now referring now to FIG. 4 which is a rear view of the user wearing the device 10 after placing the device 10 over his or her head and then placing one arm though the closed loop, the connecting material 12a is over one shoulder and also resting on the opposite side of the body above the waist and below the armpit and the ball is located behind the body. The user can place the connecting material 12a over the shoulder of their choice. Now the user can position the ball 14 to the desired location of the back muscles targeted to massage by gently holding the connecting material 12a shown in FIG. 5 and with one hand and gently sliding the connecting material 12a that is at rest in the front of the body as referred to in FIG. 5 either in an up or down direction until the ball 14 is targeted on muscle location desired.

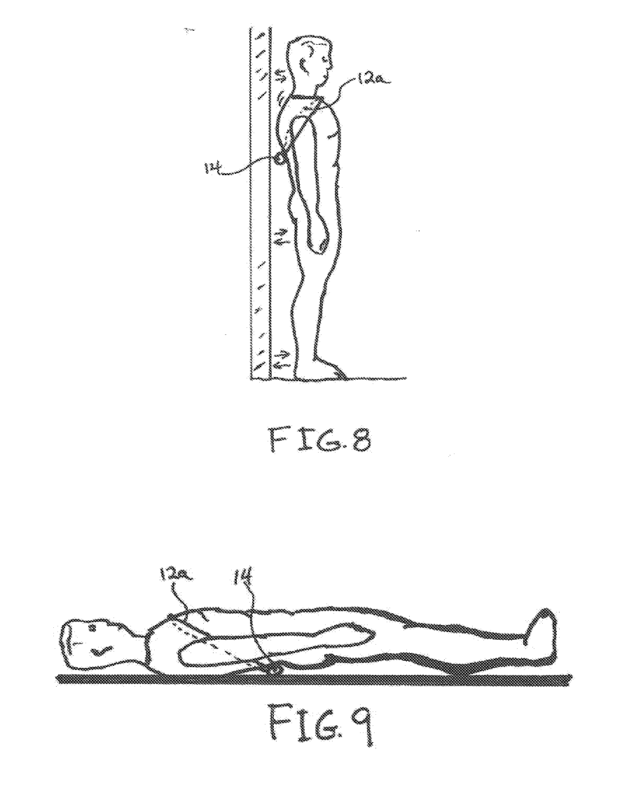

Referring now to FIG. 6 one method of adjustment is to slide with the thumb and index finger on each hand the double sliding knot adjustment 22a knots away from each other to decrease the connecting material 12a loop circumference thereby tightening the device 10 which will bring the ball closer to the body or slide the double sliding knot adjustment 22a closer together in order to increase the connecting material 12a loop circumference thereby loosening the device 10.

Once the ball 14 is positioned and adjusted comfortably to the desired region of the body the user can remove their hands as shown in FIG. 7 from the device 10 until further adjustment or a different location on the body is desired.

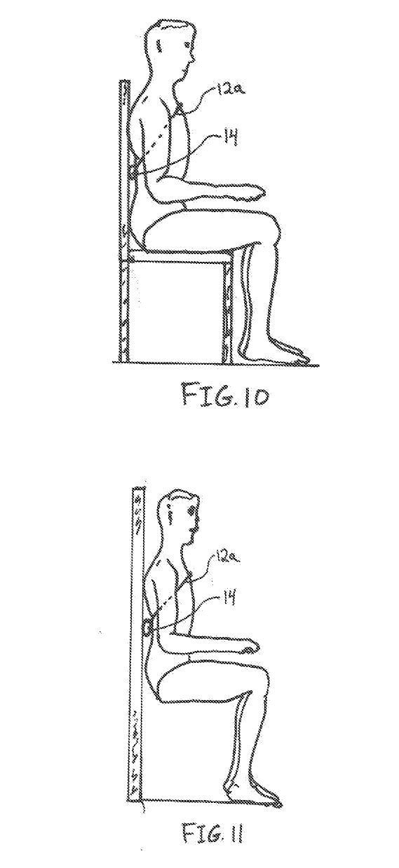

The user can now direct their own body weight towards the ball 14 while standing and leaning back against a vertical surface FIG. 8 or laying on a horizontal surface FIG. 9 or angled surface. The surface can be a hard, semi-soft or a soft surface or the user can also position themselves in a sitting position FIG. 10 or squatting position FIG. 11 against a hard, semi-soft or soft surface while applying pressure to the ball 14 and if desired shifting the users body weight left, right, up or down. The user can increase the ball 14 contact pressure by increasing the angle the body is in with relationship to the surface in contact with the ball 14 in order to administer self-massage to the back or neck while applying trigger point release techniques and/or self-realignment of the vertebrae techniques that can aid in the relief of pinched nerves without holding the device 10. Referring now to FIG. 1 if the connecting material 12a is constructed of a type of elastic band or any other type of stretchy material either fixed length or adjustable, the device 10 can be used as a muscle stretching and strengthening device while being worn in order to accompany the self-massage and trigger point therapy. The device 10 referred to in FIG. 1 can aid in increased range of motion by relaxing muscles and stretching and strengthening muscles thereby enabling better flexibility and less muscle stiffness and pain. The device 10 referred to in FIG. 1 can also be used in Kinesiotherapy as defined by Merriam-Webster Medical Dictionary: the therapeutic and corrective application of passive and active movements (as by massage) and of exercise. The device 10 referred to in FIG. 1 can be used by individuals, computer operators, office workers and athletes. In addition physical therapist, chiropractors, sports doctors can recommend the use of this device as part of a patient home therapy regime/prescription. The device 10 referred to in FIG. 1 can be used by a person with interest in using self-massage, self-healing and trigger point release techniques. Other aspects of this invention will become apparent to those skilled in the art.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, method, and examples, but by all embodiments and methods within the scope and spirit of the invention.

It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations or structures described herein as a single instance. Finally, boundaries between various components are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

The invention claimed is:

1. An apparatus for massaging a body part of a user comprising;
a housing;
a resilient body received within the housing; and
at least one connecting material;
a double sliding adjustment knot;
a gripping point;
a single sliding locking adjustment ring;
a ball container access point;
a drawstring.

2. The apparatus of claim 1, wherein the housing includes mesh container or tube like fabric.

3. The apparatus of claim 1, wherein the connecting material coupled to opposite ends of the housing.

4. The apparatus of claim 1, wherein the connecting material includes cord, rope, fabric, elastic and retractable material.

5. The apparatus of claim 1, wherein the length of the connecting material is 4 ft-6 ft.

6. The apparatus of claim 1, wherein the resilient body received within the housing is spherical or non-spherical object.

7. The apparatus of claim 1, wherein the circumference of the resilient body is 6 inch-12 inches.

8. The apparatus of claim 1, wherein the resilient body received within the housing is interchangeable.

9. The apparatus of claim 1, wherein the trigger point of the resilient body is heat, cold or vibration.

10. The apparatus of claim 1, wherein the drawstring includes zipper, hook or loop material.

11. The apparatus of claim 1, wherein the single sliding locking adjustment ring is used for resilient body positioning.

12. The apparatus of claim 1, wherein the single sliding locking adjustment ring is used for housing size adjustment.

13. The apparatus of claim 1, wherein the double sliding adjustment knot is used for connecting material adjustment.
